(19) United States
(12) Patent Application Publication
(10) Pub. No.: US 2018/0292963 A1
(43) Pub. Date: Oct. 11, 2018

(54) MEDICAL IMAGE DISPLAY APPARATUS AND PROGRAM

(71) Applicant: Konica Minolta, Inc., Chiyoda-ku Tokyo (JP)

(72) Inventors: TAKAFUMI NANJO, Ota-ku Tokyo (JP); AKIRA KURAHASHI, Hachioji-shi Tokyo (JP)

(21) Appl. No.: 15/948,188

(22) Filed: Apr. 9, 2018

(30) Foreign Application Priority Data
Apr. 10, 2017 (JP) 2017-077238

(51) Int. Cl. G06F 3/0486; G06F 3/0485; G06T 7/00

(52) U.S. Cl. CPC G06F 3/0486; G06T 2207/10116; G06T 7/0012; G06F 3/04855

(57) ABSTRACT

A medical image display apparatus includes: a display that displays a display screen having a plurality of display areas to display a medical image; and a hardware processor that displays a reference image to be used as a basis for comparative reading in one of the display areas on the display screen, and displays stacked images, which are a plurality of medical images stacked after being grouped based on a predetermined condition, in another display area thereon, wherein the hardware processor switches the medical images among the stacked images to be displayed in the another display area in response to a predetermined operation performed in the another display area.

### CROSS REFERENCE TO RELATED APPLICATIONS

The present application claims priority under 35 U.S.C. § 119 to Japanese patent Application No. 2017-077238, filed on Apr. 10, 2017, is incorporated herein by reference in its entirety.

### BACKGROUND

### Technological Field

The present invention relates to a medical image display apparatus and a program.

### Description of the Related Art

In the field of medical treatment, doctors perform diagnostic interpretation of medical images by displaying medical images generated by modalities, such as a computed radiography (CR) device, a flat panel detector (FPD) device, a computed tomography (CT) device, and a magnetic resonance imaging (MRI) device, to observe a specific part of the body.

A conventional medical image display apparatus that switches images for diagnostic interpretation of medical images in the following manner has been known in the art. A plurality of medical images is displayed as thumbnail images in a thumbnail image display area. A desired image for diagnostic interpretation of medical images is displayed by drag and drop of the corresponding thumbnail image therefrom into a display area of an image for diagnostic interpretation of medical images (see, for example, JP 2011-081607 A).

Here, drag and drop refers to an operation to press a mouse button with a mouse pointer placed on a thumbnail image, and move the mouse while keeping the mouse button pressed.

However, the technology disclosed in JP 2011-081607 A has the following problem. The distance between the thumbnail image display area and the display area of an image for diagnostic interpretation of medical images makes an operation of drag and drop burdensome. Thus, the efficiency of image reading and diagnosis is reduced.

### SUMMARY

In consideration of the above problem, an object of the present invention is to reduce the burden of operation in switching displayed images, and improve the efficiency of work.

To achieve the abovementioned object, according to an aspect of the present invention, a medical image display apparatus reflecting one aspect of the present invention comprises: a display that displays a display screen having a plurality of display areas to display a medical image; and a hardware processor that displays a reference image to be used as a basis for comparative reading in one of the display areas on the display screen, and displays stacked images, which are a plurality of medical images stacked after being grouped based on a predetermined condition, in another display area thereon, wherein the hardware processor switches the medical images among the stacked images to be displayed in the another display area in response to a predetermined operation performed in the another display area.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an entire configuration of a medical image display system according to the present embodiment;

FIG. 2 is a block diagram illustrating a functional configuration of a client terminal illustrated in FIG. 1;

FIG. 3 is a flowchart illustrating display control processing performed by a control part illustrated in FIG. 2;

FIG. 4 is an example of an initial screen;

FIG. 5 is an example of a stacked images display screen; and

FIG. 6 is another example of the stacked images display screen.

### DETAILED DESCRIPTION OF EMBODIMENTS

Hereinafter, one or more preferred embodiments of the present invention will be described with reference to the drawings. However, the scope of the invention is not limited to the disclosed embodiments.

[Configuration of Medical Image Display System 100]

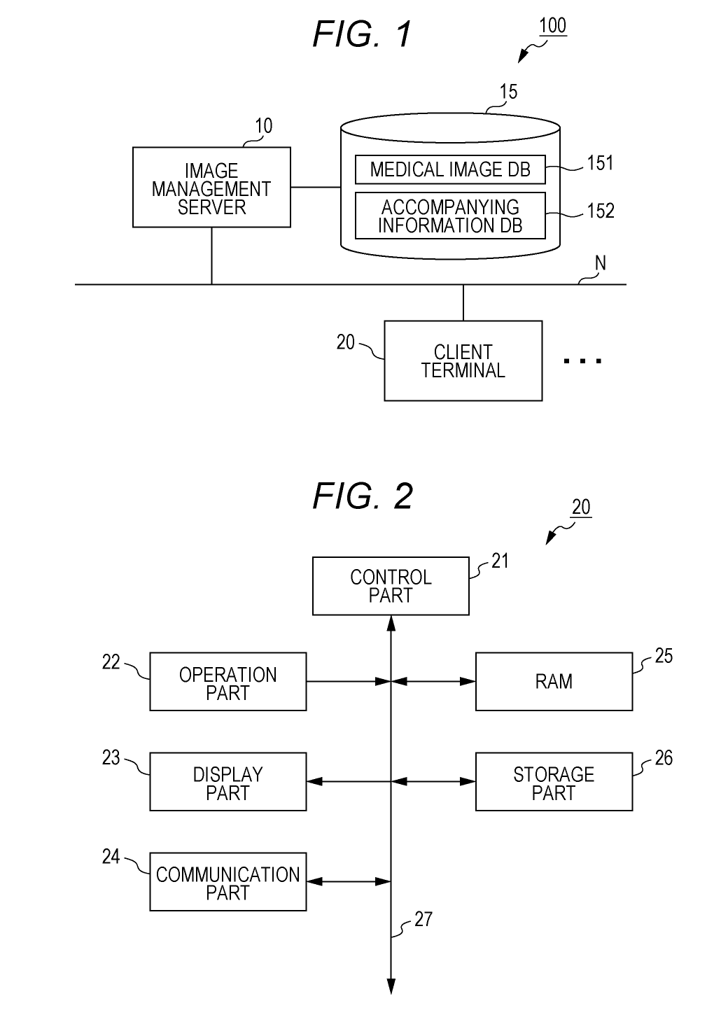

FIG. 1 illustrates an example of a system configuration of a medical image display system 100.

The medical image display system 100 is a system to be installed in a hospital. As illustrated in FIG. 1, the medical image display system 100 includes an image management server 10 and a client terminal 20 as a medical image display apparatus, which are connected to each other in a manner capable of transmitting and receiving data via a communication network N formed with a communication line such as a local area network (LAN) and a wide area network (WAN). Each of the devices that configure the medical image display system 100 is in conformity with the Digital Imaging and Communications in Medicine (DICOM) standards. Communication is performed between the devices in accordance with the DICOM standards. It should be noted that the number of each device is not particularly limited.

The image management server 10 is a computer device to accumulate, store and manage data of medical images generated by various modalities, such as a computed tomography (CT) device, a magnetic resonance imaging (MRI) device, and a computed radiography (CR) device, and accompanying information relating to the medical images. The medical images include tomographic images generated by, for example, a CT device and an MRI device, and plain radiographic images generated by a CR device.

Specifically, the image management server 10 has a storage part 15 configured by a hard disk and the like. The storage part 15 stores a medical image database (DB) 151 storing data of medical images, and an accompanying information DB 152 storing, in a searchable manner, accompanying information relating to the medical images stored in the medical image DB 151.

The medical images are stored in the medical image DB 151 in the DICOM file format in accordance with the DICOM standards. A DICOM file includes an image part and a header part. Actual data of the medical images are written into the image part, and the accompanying information relating to the medical images is written into the header part.

The accompanying information includes, for example, patient information, examination information, series information, and image detailed information.

The patient information includes various information relating to a patient of a medical image, such as patient identification information (for example, patient ID) to identify the patient, and the name, sex, and birth date of the patient.

The examination information includes various information relating to an examination, such as examination identification information (for example, examination ID) to identify the examination, an examination date, and a doctor in charge.

The series information includes various information relating to a series, such as a series number to identify the series in the same examination, the type of a modality which has generated medical images included in the series, an examined body part, and the interval and the total number of slices in the case of the medical images being tomographic images.

Here, the series refers to a series of mutually related medical images. For example, a CT device and an MRI device generate a plurality of (a hundred to several thousand) tomographic images by continuous shooting of the plurality of images of a certain area of a body (for example, from the chest to the abdomen) along a body axis direction (for example, a direction from the head to the feet) at predetermined slice intervals (for example, at intervals of 1 mm). A group of tomographic images generated as described above is treated as one series. All the tomographic images belonging to the same series are accompanied by identical series information. The total number of slices is the total number of tomographic images belonging to the same series.

The image detailed information includes various information relating to an image such as an image number, a slice position (a position of each tomographic image in the body axis direction at the time of capturing an image with respect to the position (a reference position), defined as 0 mm in the body axis direction, of a tomographic image captured first in the same series), an image generation time, a file path name indicating the storage location of the medical image, an examination comment, a measurement position of a lesion, and a measurement result.

The image numbers 1 to n (n is the total number of slices) are numbers indicating the order of capturing medical images that are generated as the same series

In response to a retrieval request from the client terminal 20, the image management server 10 retrieves, based on the accompanying information DB 152, medical images which meet a condition transmitted from the client terminal 20, and transmits, to the client terminal 20, list data of the medical images which meet the condition via the communication network N. In addition, data of a medical image, an acquisition request of which has been received from the client terminal 20, are read from the medical image DB 151 and transmitted to the client terminal 20.

[Configuration of Client Terminal 20]

The client terminal 20 is a computer device to acquire a medical image which is accumulated and stored in the image management server 10, and display the medical image for a doctor to perform image reading.

FIG. 2 illustrates a functional configuration of the client terminal 20.

As illustrated in FIG. 2, the client terminal 20 includes a control part 21, an operation part 22, a display part 23 as a display means, a communication part 24, a RAM 25, and a storage part 26, which are connected to each other via a bus 27.

The control part 21 includes a central processing unit (CPU) and the like. The control part 21 reads various processing programs stored in the storage part 26 such as a system program and a display control processing program, develops the programs in a work area formed in the RAM 25, and controls each part in accordance with the programs. The control part 21 functions as a grouping means and a display control means.

The operation part 22 includes a keyboard, which includes cursor keys, numeric input keys, and various function keys, and a pointing device such as a mouse. The operation part 22 outputs, to the control part 21, an instruction signal input by a key operation on the keyboard and a mouse operation.

The display part 23, which includes a monitor such as a liquid crystal display (LCD) and a cathode ray tube (CRT), displays various screens, medical images, and others in accordance with instructions of display signals input from the control part 21.

The communication part 24 includes a LAN adapter, a router, a terminal adapter (TA), and the like, and transmits/receives data to/from each device connected to the communication network N.

The RAM 25 forms a work area to temporarily store various programs read from the storage part 26 in various processing subject to execution control by the control part 21, input or output data, parameters, and others.

The storage part 26 includes a hard disc drive (HDD), a nonvolatile semiconductor memory, and the like.

The storage part 26 stores a system program to be executed by the control part 21, various programs including the display control processing program, and data required to execute these programs. The various programs are stored in the storage part 26 in the form of computer readable program codes. The control part 21 sequentially performs operations in accordance with the program codes.

[Operation of Client Terminal 20]

Next, operations of the present embodiment will be described.

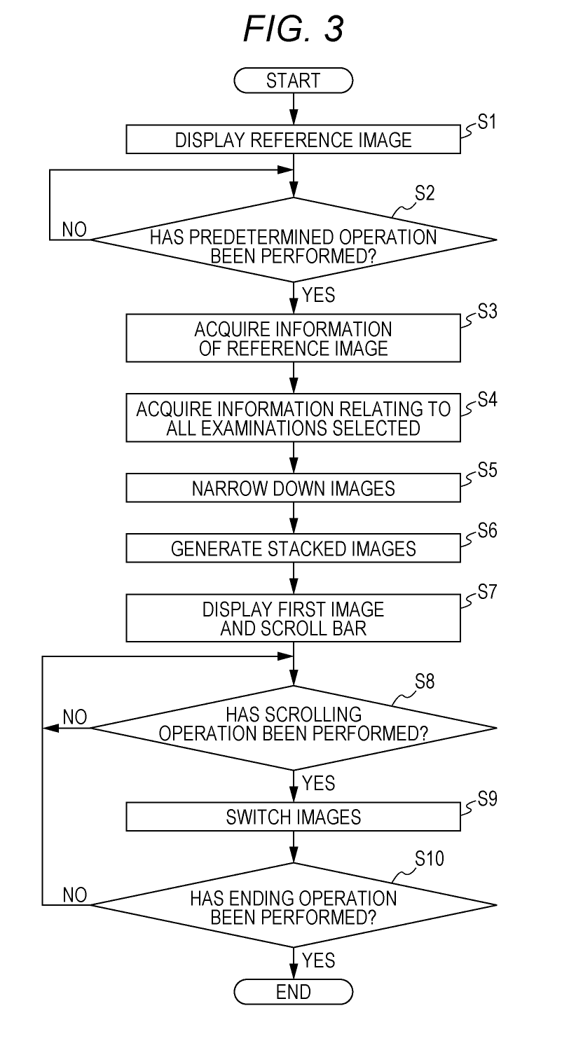

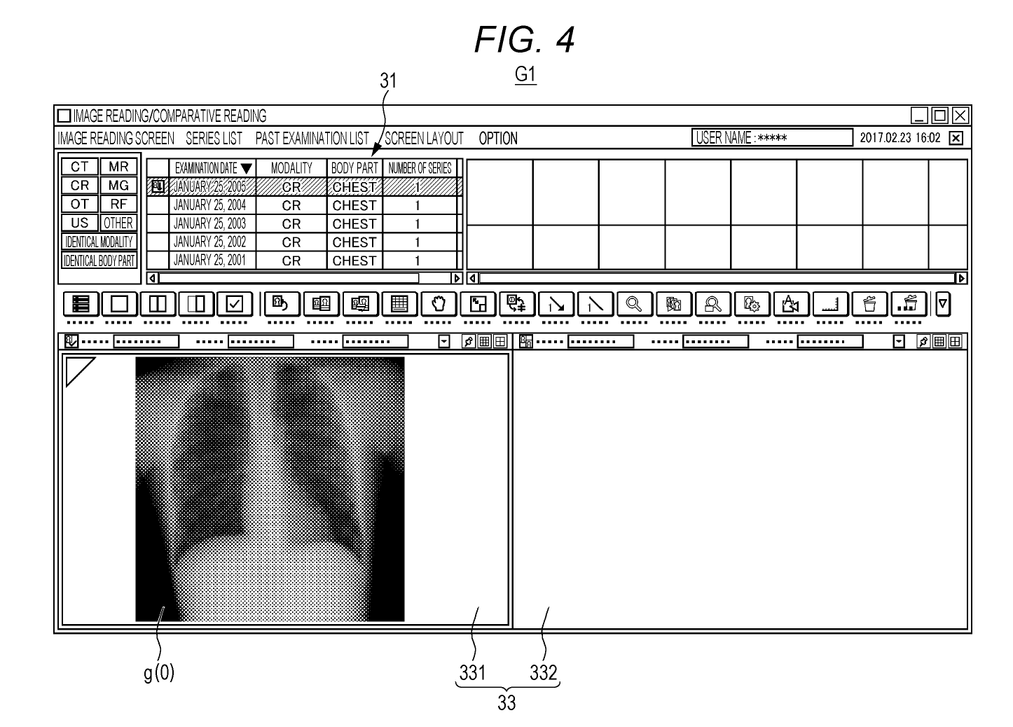

FIG. 3 illustrates a flow of display control processing performed to display, on the display part 23 of the client terminal 20, medical images for comparative reading.

The display control processing is implemented by software processing under cooperation between the control part 21 and the display control processing program stored in the storage part 26.

First, a user such as a doctor specifies a patient for whom image reading is performed by an operation via the operation part 22. Consequently, the control part 21 acquires a reference image and an examination list of the specified patient from the image management server 10.

Then, the control part 21 causes the display part 23 to display an initial screen G1 that includes the acquired examination list and reference image (step S1).

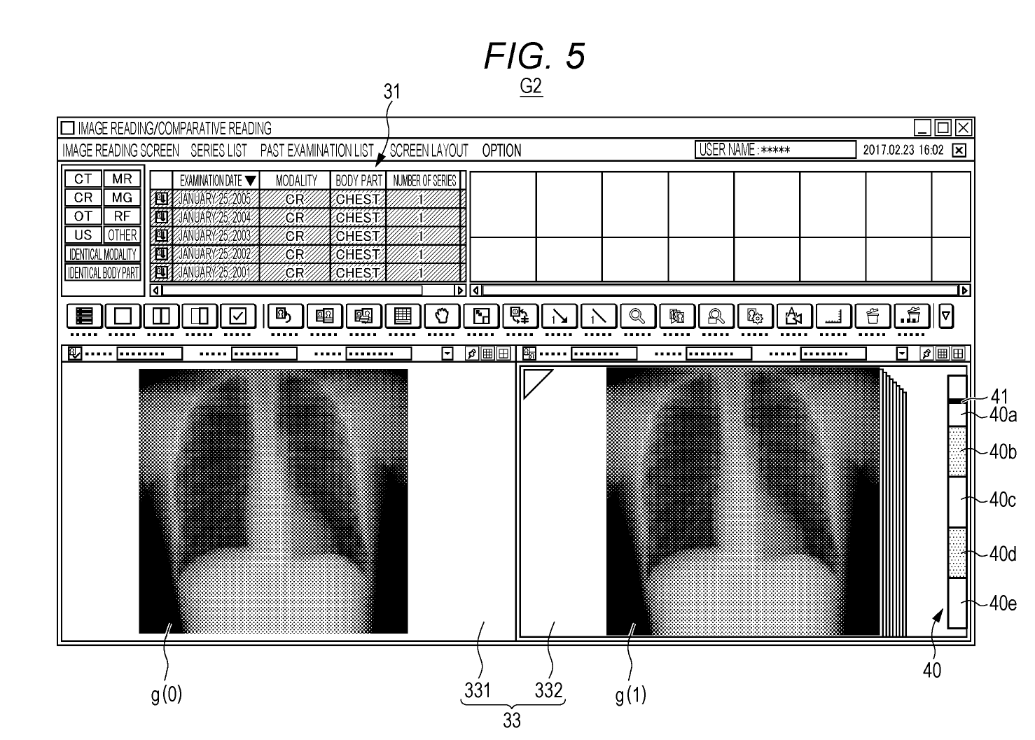

FIG. 4 illustrates an example of the initial screen G1.

As illustrated in FIG. 4, the initial screen G1 includes an examination list display area 31 and an image display area 33, and others.

The examination list display area 31 is an area to display the examination list. The examination list includes a record having items such as an examination date, a modality, an examined body part, and a number of series.

The image display area 33 has two display areas 331 and 332 that are horizontally arranged side by side.

One of the display areas, the display area 331, is an area to display a reference image g(0). Here, the reference image g(0) is an image to be used as a basis for comparative reading. Examples of the reference image g(0) include a medical image generated on any given date and a general image including a lesion of the patient.

The other display area, the display area 332, is an area to display an image for diagnostic interpretation of medical images to be compared with the reference image g(0) in comparative reading. As illustrated in FIG. 4, the display area 332 is blank on the initial screen G1.

Returning to FIG. 3, the control part 21 then determines whether an operation signal corresponding to a predetermined operation on the initial screen G1 has been detected via the operation part 22 (step S2). If no operation signal has been detected (step S2: NO), the control part 21 repeats the processing of step S2.

Here, the predetermined operation refers to, for example, an operation to select a record from the examination list in the examination list display area 31 and drag and drop the record into the display area 332.

It should be noted that the predetermined operation is not limited to the above. For example, it is possible to adopt a configuration to provide an operation button to collectively select all the records of the examination list on the initial screen G1, and recognize an operation of the operation button as the predetermined operation.

If the operation signal corresponding to the predetermined operation has been detected (step S2: YES), the control part 21 acquires information (the examination information and the series information) of the reference image g(0) displayed on the initial screen G1 (step S3).

Next, the control part 21 acquires information (the examination information and the series information) relating to examinations of all the records selected by the operation performed in step S2 above (step S4).

Then, based on the information of the reference image g(0) acquired in step S3 above, the control part 21 narrows down the information relating to the examinations of all the selected records which has been acquired in step S4 above (step S5).

Specifically, based on, for example, the type of modality and the examined body part (information relating to the reference image) included in the information of the reference image g(0), the control part 21 selects information (information of medical images of examinations relating to the reference image) including the identical type of modality or the identical examined body part from the information relating to the examinations of all the selected records.

Examples of the medical images of the examinations relating to the reference image g(0), which are to be selected as a result of the above, include an image of an identical examined body part captured by an identical type of modality, an image of an identical examined body part captured by a different type of modality, and an image of a different examined body part captured by an identical type of modality, with respect to the reference image g(0). It should be noted that the images listed above as the medical images to be selected are just examples. It goes without saying that medical images can be selected based on information other than the type of modality and the examined body part.

Next, the control part 21 acquires, from the image management server 10, images corresponding to the information narrowed down in step S5 above, sorts the acquired images in a predetermined order (for example, in the order of examination date and time from newest to oldest), and generates stacked images (images for diagnostic interpretation of medical images) g(x) which are stacked (that is, grouped) in the sorted order (step S6).

Then, the control part 21 displays, in the display area 332, a first one g(1) of the stacked images g(x) generated in step S6 above, and also displays a scroll bar 40 in the display area 332 (step S7). Hereinafter, a screen on which the stacked images g(x) and the scroll bar 40 are displayed is referred to as a stacked images display screen G2.

Next, the control part 21 determines whether an operation signal corresponding to a scrolling operation by the scroll bar 40 on the stacked images display screen G2 has been detected via the operation part 22 (step S8). If the operation signal has been detected (step S8: YES), the control part 21 switches among the stacked images g(x) (step S9). Meanwhile, if no operation signal corresponding to the scrolling operation has been detected (step S8: NO), the processing of step S8 is repeated.

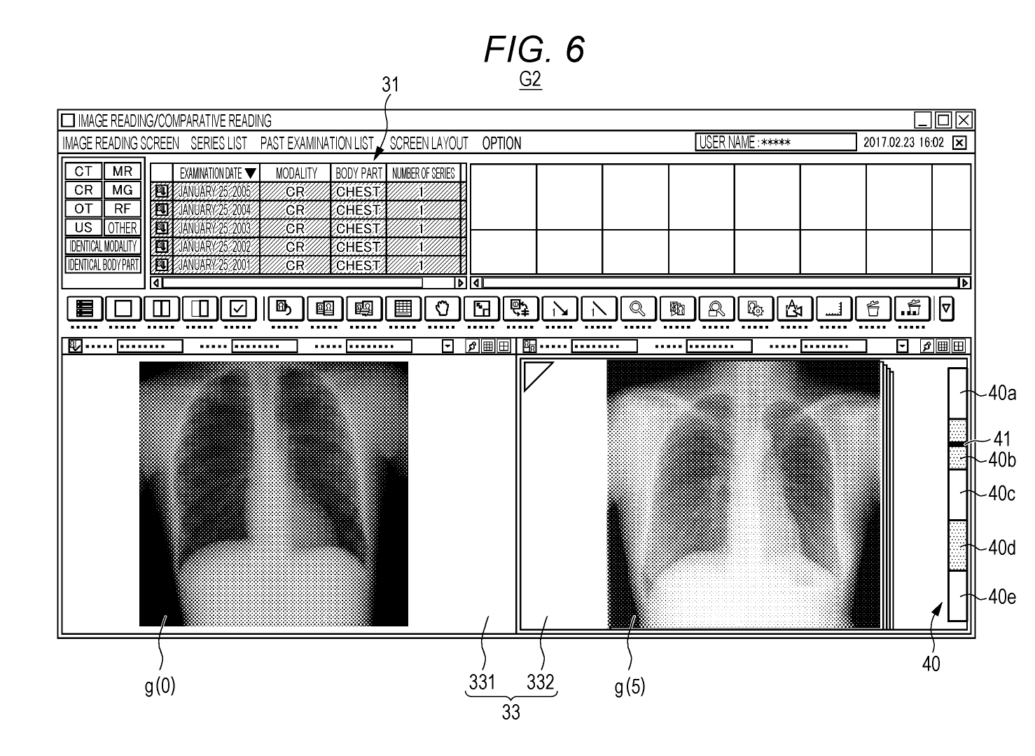

FIG. 5 illustrates an example of the stacked images display screen G2. In addition, FIG. 6 illustrates an example of the stacked images display screen G2 on which the stacked images g(x) have been switched.

As illustrated in FIG. 5, the stacked images g(x) and the scroll bar 40 are displayed in the display area 332 on the stacked images display screen G2.

In the display area 332, the stacked images g(x) are displayed in a pattern in which multiple images are stacked. Thus, a user can easily recognize that the images are stacked. It should be noted that an aspect of the stacked images g(x) being displayed is not limited to the above. The stacked images g(x) may be displayed in a pattern of a single image.

The scroll bar 40 is arranged at the end of the display area 332 while extending along the vertical direction of the display area 332.

The scroll bar 40 corresponds to the stacked images g(x). As illustrated in FIG. 6, with a scrolling operation by the scroll bar 40, a mark 41 is moved on the scroll bar 40, and images to be displayed are switched in the display area 332. In other words, the mark 41 indicates the position of an image being displayed in the display area 332.

Furthermore, the scroll bar 40 is divided into a plurality of blocks 40a, 40b . . . , which are alternately colored (here, colored in gray and white), forming a stripe pattern as a whole.

Each of the blocks serves to sort images by examination (an examination of each record selected by the operation of step S2 above) into groups of images.

Consequently, owing to the blocks including the block 40a and the mark 41 on the scroll bar 40, a user can intuitively perceive the position of an examination among all the selected examinations sorted in the predetermined order and the position of an image being displayed counting from the first one in the group of images corresponding to the examination.

Returning to FIG. 3, the control part 21 determines whether an operation signal corresponding to an operation of an ending instruction has been detected via the operation part 22 (step S10). If no operation signal has been detected (step S10: NO), processing returns to step S8 above, and the processing of S8 and thereafter is repeated.

Meanwhile, if the operation signal corresponding to the operation of the ending instruction has been detected (step S10: YES), the control part 21 terminates the present processing.

As described above, the client terminal 20 according to the present embodiment includes the display part 23 and the control part 21. The display part 23 displays the stacked images display screen G2 having the plurality of display areas to display medical images. The control part 21 displays the reference image g(0) to be used as a basis for comparative reading in the display area 331 on the stacked images display screen G2, and also displays the stacked images g(x) as a plurality of medical images stacked after being grouped based on a predetermined condition, in the display area 332. In response to a predetermined operation in the display area 332, the control part 21 switches the medical images among the stacked images g(x) to be displayed in the display area 332.

Therefore, no drag and drop action is required in switching a medical image being displayed to another, resulting in reducing the burden of operation and improving work efficiency.

Furthermore, according to the present embodiment, the control part 21 selects medical images of examinations relating to the reference image g(0) from among a plurality of medical images of a patient based on the information relating to the reference image g(0), and generates the stacked images g(x) by grouping the selected medical images.

Thus, it is possible to efficiently generate the stacked images g(x) in accordance with the reference image g(0), which is used as a basis for comparative reading.

In addition, according to the present embodiment, the control part 21 displays the scroll bar 40 linked to the stacked images g(x) in the display area 332.

As a result, it is possible to switch the stacked images g(x) by using the scroll bar 40.

Moreover, according to the present embodiment, the scroll bar 40 has the mark 41 to indicate a position, among the stacked images g(x), of an image being displayed in the display area 332. In accordance with a moving operation of the mark 41 on the scroll bar 40, the control part 21 switches and displays the stacked images g(x) in the display area 332.

Thus, a user can easily switch the stacked images g(x) by operating the scroll bar 40.

Furthermore, according to the present embodiment, the scroll bar 40 has the plurality of blocks 40a, 40b . . . , which sorts the stacked images g(x) by examination into groups of images. The plurality of blocks 40a, 40b . . . is displayed in different colors to attain easy distinguishability therebetween.

Accordingly, a user can intuitively perceive which image of which one of the examinations selected from the list is being displayed.

In the above embodiment, a configuration of the control part 21 generating the stacked images g(x) in accordance with an operation of selection from the examination list has been described as an example. Meanwhile, the following configuration is also possible. Stacked images g(x) generated in advance are stored in, for example, the image management server 10. Then, the stacked images g(x) are read therefrom and displayed in the display area 332.

In addition, a configuration of switching of the stacked images g(x) by using the scroll bar 40 has been described as an example in the above embodiment. Meanwhile, an operation means other than the scroll bar 40 may be used to perform the switching operation of the stacked images g(x). For example, the switching of the stacked images g(x) may be performed by a drag operation of a mouse with a mouse pointer placed in the display area 332 in which the stacked images g(x) are displayed. The switching of the stacked images g(x) may also be performed by, for example, a key down operation on the keyboard with a cursor placed in the display area 332.

Other detailed configuration and detailed operation of each part which configures the medical image display apparatus may also be changeable as appropriate without departing from the scope of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. A medical image display apparatus comprising:
a display that displays a display screen having a plurality of display areas to display a medical image; and
a hardware processor that displays a reference image to be used as a basis for comparative reading in one of the display areas on the display screen, and displays stacked images, which are a plurality of medical images stacked after being grouped based on a predetermined condition, in another display area thereon,
wherein the hardware processor switches the medical images among the stacked images to be displayed in the another display area in response to a predetermined operation performed in the another display area.

2. The medical image display apparatus according to claim 1, wherein
the hardware processor selects medical images of examinations relating to the reference image from among a plurality of medical images of a patient based on information relating to the reference image, and generates the stacked images by grouping the selected medical images.

3. The medical image display apparatus according to claim 1, wherein
the hardware processor displays, in the another display area, a scroll bar that is linked to the stacked images and used to perform the predetermined operation.

4. The medical image display apparatus according to claim 3, wherein
the scroll bar has a mark that indicates a position, among the stacked images, of an image being displayed in the another display area, and
the hardware processor switches and displays the stacked images in the another display area in accordance with an operation of moving the mark on the scroll bar.

5. The medical image display apparatus according to claim 3, wherein
the scroll bar has a plurality of blocks that sorts the stacked images by examination into groups of images, and
the plurality of blocks is displayed in different colors to be distinguishable from one another.

6. A non-transitory recording medium storing a computer readable program causing a computer to function as:
a hardware processor that displays a reference image to be used as a basis for comparative reading in one of a plurality of display areas on a display screen, and displays stacked images, which are a plurality of medical images stacked after being grouped based on a predetermined condition, in another display area thereon, the display screen having the plurality of display areas to display a medical image,
wherein the hardware processor switches the medical images among the stacked images to be displayed in the another display area in response to a predetermined operation performed in the another display area.
